(19) United States
(12) Patent Application Publication
(10) Pub. No.: US 2024/0357379 A1
(43) Pub. Date: Oct. 24, 2024

(54) Configuring a Radio Access Node to Use One or More Radio Access Network Functions

(71) Applicant: Telefonaktiebolaget LM Ericsson (publ), Stockholm (SE)

(72) Inventors: Erik Christian Gullberg, Uppsala (SE); Rerngvit Yanggratoke, Järfälla (SE); Lukas Bjarre, Hägersten (SE); Samara Keshavarz Hedayati, Stockholm (SE)

(21) Appl. No.: 18/292,141

(22) PCT Filed: Jul. 26, 2021
(86) PCT No.: PCT/EP2021/070891

§ 371 Date: Jan. 25, 2024

(51) Int. Cl. H04W 24/02; H04L 41/16

(52) U.S. Cl. CPC H04W 24/02; H04L 41/16

(57) ABSTRACT

The present disclosure provides a method of configuring a Radio Access Network (RAN) node to use one or more RAN functions. The method comprises obtaining input data for the RAN node, in which the input data comprises configuration information performance information for the RAN node. Based on the input data, one or more target performance indicators and a constraint on one or more resources for the RAN node, an optimisation process is used to select one or more RAN functions for activation by the RAN node. The optimisation process uses one or more models for predicting, based on the input data and a selection of RAN functions, usage of the one or more resources and a value of the one or more target performance indicators. The RAN node is configured to use the one or more selected RAN functions.

### TECHNICAL FIELD

Embodiments of the present disclosure relate to radio access networks and particularly to methods, apparatus and machine-readable mediums for configuring a radio access node to use one or more radio access network functions.

### BACKGROUND

In wireless communications networks, wireless devices are typically connected to a core network via one or more base stations in a radio access network (RAN). The functionality of a base station in a RAN can be logically split across two units: a central unit (CU) and a distributed unit (DU).

FIG. 1 shows four exemplary RANs: a Distributed RAN (D-RAN) 110, a Centralised RAN (C-RAN) 120, a D-RAN with high-layer split (HLS) virtualised RAN 130 and a C-RAN with HLS virtualised RAN 140. Each of these RANs is operable to connect one or more wireless devices (not shown) to a core network 100 (e.g. by one or more backhaul links).

In the D-RAN 110, the CU and DU for a base station are collocated at the base station site. Thus, for example, a base station in the D-RAN 110 may comprise a baseband unit (BBU) and a remote radio unit (RRU) or remote radio head (RRH) which are both located at the site. In contrast, in the C-RAN 120, baseband processing for multiple base station sites is performed at a central location. Thus, the CU and DU are remote from the radio equipment, as illustrated in FIG. 1.

Further information on different RAN architectures can be found in 5G New Radio RAN and transport choices that minimize TCO, Ericsson Technology Review #10, 7 Nov. 2019.

### SUMMARY

Base stations are increasingly being provided with additional functions or features which can optimise performance, minimise resource consumption and enhance functionality. This functions may be implemented in software such that they can be activated at a particular base station by executing one or more files. Examples of these functions are shown in FIG. 2, which shows an Open RAN (O-RAN) base station 200 and an orchestration and automation unit 202 in a communications network. The orchestration and automation unit 202 may comprise a management and orchestration unit (MANO), for example. The orchestration and automation unit 202 comprises a non-real time Radio or RAN Intelligent Controller (RIC; not illustrated) which can provide various functions for the base station 200, including policy and service management, RAN analytics and model training.

The base station 200 comprises a near-real time RIC 206, which is a software platform for hosting software RAN functions. Examples of these software RAN functions include Radio Connection Management (RCM) 204a, Mobility Management (MM) 204b, Quality of Service (QoS) Management 204c and Interference Management (IM) 204d. The near-real time RIC 206 further comprises a RAN database 208 storing other RAN functions that can be executed by the base station 200.

FIG. 2 shows just some examples of the types of RAN functions that can be activated by a base station. There are various types of RAN functions, and their associated advantages may be situation specific, depending on, for example, the type of or volume of traffic, the location of the base station, the frequency bands used by the base station, the distance to the closest neighbouring base station (the inter-site distance) etc. Therefore, some RAN functions may be more beneficial to some base stations than others.

In addition, running RAN functions can be resource intensive and thus it is often not feasible to run all of the available RAN functions at a particular base station at once. RAN functions are typically executed by the baseband unit (BBU), which means resource constraints can pose a particular issue for base stations in which the BBU is at the base station site (such as base stations in a D-RAN). Base station sites often have limited resources in terms of processing power, storage, memory etc., which limits which functions (and combinations of functions) can run at the base station. In addition, base stations may also have a limited number of network and/or radio resources available, which adds another layer of constraints.

Embodiments of the present disclosure seek to address these and other problems.

A method of configuring a RAN node to use one or more RAN functions is provided. The method comprises obtaining input data for the RAN node. The input data comprises configuration information and performance information for the RAN node. Based on the input data, one or more target performance indicators and a constraint on one or more resources for the RAN node, an optimisation process is used to select one or more RAN functions for activation by the RAN node. The one or more RAN functions are selected from a plurality of RAN functions. The optimisation process is configured to select the one or more RAN functions using one or more models for predicting, based on the input data and a selection of RAN functions, usage of the one or more resources and a value of the one or more target performance indicators. The method further comprises configuring the RAN node to use the one or more selected RAN functions.

In a further aspect, an apparatus configured to perform the aforementioned method is provided. In another aspect, a computer program is provided. The computer program comprises instructions which, when executed on at least one processor of an apparatus, cause the apparatus to carry out the aforementioned method. In a further aspect, a carrier containing the computer program is provided, in which the carrier is one of an electronic signal, optical signal, radio signal, or non-transitory machine-readable storage medium.

A still further aspect of the present disclosure provides an apparatus for configuring a RAN node to use one or more RAN functions. The apparatus comprises processing circuitry and a machine-readable medium, in which the machine-readable medium contains instructions executable by the processing circuitry such that the apparatus is operable to obtain input data for the RAN node. The input data comprises configuration information and performance information for the RAN node. The apparatus is further operable to, based on the input data, one or more target performance indicators and a constraint on one or more resources for the RAN node, use an optimisation process to select one or more RAN functions for activation by the RAN node. The one or more RAN functions are selected from a plurality of RAN functions. The optimisation process is configured to select the one or more RAN functions using one or more models for predicting, based on the input data and a selection of RAN functions, usage of the one or more resources and a value of the one or more target performance indicators. The apparatus is further operable to configure the RAN node to use the one or more selected RAN functions.

Embodiments disclosed herein provide a method and apparatus for dynamically adapting the functionality of a RAN node by configuring the RAN node to use one or more RAN functions that are selected based on the configuration and performance of the RAN node. This tailored approach advantageously improves the performance of the RAN node whilst minimising additional overhead.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 shows exemplary Radio Access Networks (RANs) connected to a core network;

FIG. 2 shows a block diagram of an exemplary architecture for a communications network;

FIG. 3 shows an example of a communications network according to embodiments of the disclosure;

FIGS. 4-6 show flowcharts of methods according to embodiments of the disclosure;

FIG. 7 shows a diagram of a signalling flow according to embodiments of the disclosure;

FIG. 8 shows a flowchart of a method according to embodiments of the disclosure; and

FIGS. 9 and 10 show examples of an apparatus according to embodiments of the disclosure.

### DETAILED DESCRIPTION

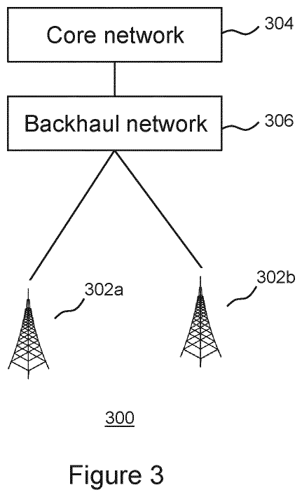

FIG. 3 shows a communications network 300 according to embodiments of the disclosure. The communications network may implement any suitable wireless communications protocol or technology, such as Global System for Mobile communication (GSM), Wide Code-Division Multiple Access (WCDMA), Long Term Evolution (LTE), New Radio (NR), WiFi, WiMAX, or Bluetooth wireless technologies. In one particular example, the communications network 300 forms part of a cellular telecommunications network, such as the type developed by the 3^{rd} Generation Partnership Project (3GPP). Those skilled in the art will appreciate that various components of the communications network are omitted from FIG. 3 for the purposes of clarity.

The network 300 comprises a first radio access network (RAN) node 302a and a second RAN node 302b (collectively 302). The RAN nodes 302 are connected to a core network 304 via a backhaul network 306. In the illustrated embodiment, two RAN nodes 302 are shown, although the skilled person will appreciate that the network 300 may comprise any number of RAN nodes and may comprise many more RAN nodes than shown. The RAN nodes 302 may comprise base stations such as, for example, radio base stations, Node Bs, evolved Node Bs (eNB) or NR NodeBs (gNB).

The first RAN node 302a has access to a plurality of RAN functions that it can run. In this context, a RAN function (e.g. RAN feature) comprises a software program that can be run (e.g. activated or executed) by the first RAN node 302a. The RAN functions may be available at the first RAN node 302a. For example, the executable software programs for the RAN functions may be stored at the first RAN node 302a. To activate one of these RAN functions, the first RAN node 302a may thus execute the relevant stored software program. Alternatively, one or more of the RAN functions may be available to the first RAN node 302a on request. For example, some or all of the executable software programs may be stored at another node in the communications network 300, such as a node in the core network 304, for example. The first RAN node 302a may access such software programs by sending a request to the other node and receiving, in response, one or more executable files.

The skilled person will appreciate that the RAN functions may have various functionalities or purposes. Examples of RAN functions are provided in Appendix A. Particular RAN functions may improve the performance of the first RAN node 302a by, for example, reducing latency, increasing coverage and/or reducing resource usage etc. Some RAN functions may be particularly beneficial depending on the circumstances in which they are used. One such example is an Uplink Coordinated Multi-Point Reception function which, when executed at a RAN node, is operable to combine antenna signals from multiple sector carriers in different cells to increase uplink throughput. This can be particularly effective for wireless devices at cell borders. The uplink throughput gains for users at cell borders can depend on the load and scenario in which the RAN node is deployed. The gain is particularly significant for a wireless device that is connected to a macro cell close to a micro cell. As a result, it can be particularly advantageous for a RAN node to activate this function if it serves a macro cell neighbouring a micro cell. In contrast, a RAN node serving only wireless devices that are clustered towards the centre of the cell may experience more limited benefits of this functionality.

Different RAN functions may thus offer different benefits to the first RAN node 302 depending on, for example, the context in which the first RAN node 302 is operating (e.g. its traffic, location, inter-site distance etc.) and its configuration (e.g. frequency bands etc.). In addition, the suitability of RAN functions for the first RAN node 302 may vary over time. For example, if the first RAN node 302 is near to a sports stadium, it may be advantageous to run RAN functions which optimise capacity during a sports game when the number of devices seeking connectivity would be expected to increase. However, between games, when demand is expected to be lower, it may be advantageous to run RAN functions which conserve energy.

Resource limitations at the first RAN node 302 add a further layer of complexity. It may not be technically feasible to activate all of the RAN functions available to the first RAN node 302 due to limited resources (e.g. processing power, memory, storage, networking resources etc.) at the site of the first RAN node 302. Thus, the advantages of any particular RAN function should be balanced against its resource cost.

One way of determining which RAN functions to run at the first RAN node 302 is to manually select one or more RAN functions based on the properties of the first RAN node 302. Thus, for example, a radio engineer can select RAN functions to be activated by the first RAN node 302 based on the environment in which the first RAN node 302 is deployed (e.g. whether it is urban, suburban or rural), the intersite distance, its location, frequency band and/or antenna/sector configuration etc. However, this is difficult to scale to large numbers of RAN nodes, as the selection of RAN functions for each RAN node would need to be manually optimised by a radio engineer. In addition, it would be difficult to dynamically adapt the RAN functions running at a RAN node in response to any changes.

A more scalable solution involves categorising RAN nodes according to a plurality of categories and generating templates indicating which RAN features should be activated at particular RAN node based on its categorisation. For example, one template set of RAN functions may be provided for rural sites and another template set of RAN functions may be provided for urban sites. Although using templates can reduce implementation costs, these templates may not account for variation between RAN nodes within any particular category. In addition, it is difficult to dynamically adapt the selection of RAN functions in response to changes in a template-based approach.

The present disclosure seeks to address these and other problems. A method of configuring a RAN node to use one or more RAN functions is provided. The method comprises obtaining input data for the RAN node in which the input data comprises configuration information and performance information. Based on the input data, one or more target performance indicators and a constraint on one or more resources for the RAN node, one or more RAN functions are selected for activation by the RAN node. The one or more RAN functions are selected from a plurality of RAN functions using an optimisation process. The optimisation process is configured to select the one or more RAN functions using one or more models for predicting, based on the input data and a selection of RAN functions, usage of the one or more resources and a value of the one or more target performance indicators. The method further comprises configuring the RAN node to use the one or more selected RAN functions.

By selecting the one or more RAN functions for activation by the RAN node based on one or more target performance indicators and a constraint on one or more resources for the RAN node, embodiments of the present disclosure provide a method by which RAN functions can be used to optimise RAN node performance even when there are only limited resources available to the RAN node. Inputting the configuration information and performance information of the RAN node into the optimisation process means that the optimisation process can tailor its selection of RAN functions to the specific needs of the RAN node, further improving performance. By using the one or more models for predicting usage of the one or more resources and a value of the one or more target performance indicators, the optimisation process can assess how a particular selection of RAN functions may affect resource usage and performance given the current properties of the RAN node.

Embodiments disclosed herein thus provide an efficient method for dynamically adapting the functionality of the RAN node. This tailored approach, in which the selection of RAN functions is based on information that is specific to the RAN node, further improves the performance of the RAN node whilst minimising operational costs.

Thus, according to embodiments of the disclosure, the first RAN node 302 may be configured to use one or more RAN functions. The optimisation process is used to select one or more RAN functions for activation by the first RAN node 302 from a plurality of RAN functions that are available to the first RAN node 302. The optimisation process uses input data, a constraint on one or more resources of the first RAN node 302 and one or more target performance indicators for the first RAN node 302.

The input data comprises configuration information and performance information for the first RAN node 302. The input data may thus be indicative of the operation of the first RAN node 302 and network performance for the first RAN node 302, for example.

The optimisation process seeks to identify a selection of one or more RAN functions which optimises the performance of the first RAN node 302 as indicated by the one or more target performance indicators, subject to the constraint on the one or more resources. Thus, the one or more target performance indicators comprise one or more performance indicators (e.g. key performance indicators, KPIs) that the optimisation process seeks to optimise. For some of these performance indicators, optimising these performance indicators comprises seeking to maximise their value. Examples of such performance indicators may include Session Setup Success Rate (SSSR) and throughput (such as downlink user throughput, DLUT).

For other performance indicators, smaller values may be preferable. Thus, a minimal value of some performance indicators may indicate that performance of the RAN node is maximised. For these performance indicators, optimisation can comprise seeking to minimise their value. Examples of such performance indicators may include latency (such as downlink latency, LAT_DL) and power consumption.

In some situations, there may be other performance indicators which are considered to be optimised provided they satisfy a constraint. For a RAN node at a rural site, for example, an optimal solution may maximise coverage provided a minimum capacity threshold is exceeded. Thus, the one or more target performance indicators for that RAN node may comprise a first target performance indicator (coverage) which the optimisation process seeks to maximise and a second target performance indicator (capacity) that the optimisation process seeks to satisfy a constraint (exceeding a minimum threshold).

Thus, the one or more target performance indicators may comprise, for example, one or more performance indicators that the optimisation process is to seek to maximise (e.g. SSSR, DLUT), minimise (e.g. LAT_DL, power consumption), or determine to satisfy a constraint.

The constraint on one or more resources may comprise an upper limit on a particular resource of the first RAN node 302 such as, for example, a maximum process usage (e.g. Central Processing Unit, CPU usage) or a maximum memory usage. The optimisation process can thus seek to select one or more RAN functions that satisfy the resource constraint and optimise the one or more target performance indicators based on the configuration and performance of first RAN node 302.

The optimisation process selects the one or more RAN functions using one or more models. The models can be used to predict, for a given selection of RAN functions for the first RAN node 302, usage of the one or more resources and a value of the one or more target performance indicators. The optimisation process can thus, for example, use the models to explore the parameter space of possible combinations of RAN functions for the first RAN node 302.

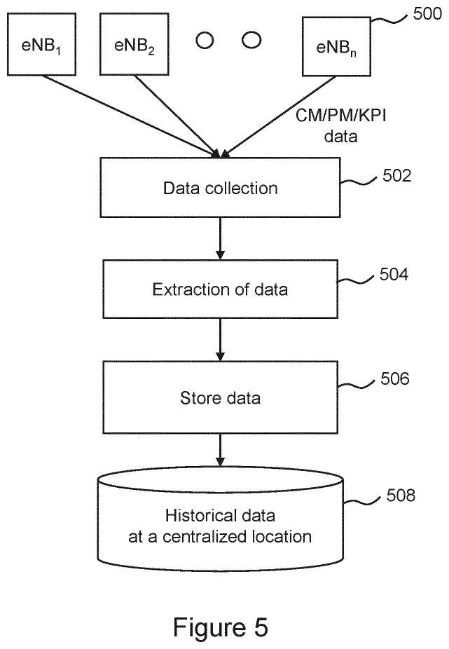

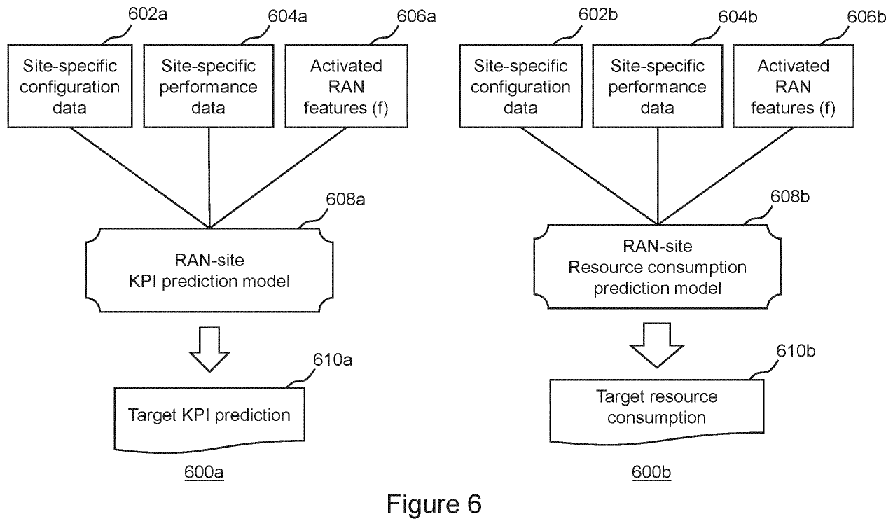

In particular examples, the models may be developed using training data for a plurality of RAN nodes. The models may be developed using training data for both the first RAN node 302a and the second RAN node 302b, for example. Briefly, the training data comprises configuration information, performance information and RAN function activation information for the plurality of RAN nodes. The collection of the training data and development of the one or more models are discussed in more detail below in respect of FIGS. 5 and 6.

The optimisation process thus selects the one or more RAN functions for the first RAN node 302a. The RAN node is configured to use the one or more selected RAN functions. For example, when the method is performed by the first RAN node 302a, the first RAN node 302a can activate any of the selected RAN functions which are not already running at the first RAN node 302a. The first RAN node 302a may, additionally or alternatively, deactivate one or more RAN functions which were not selected by the optimisation process. Since a RAN function may comprise one or more executable software programs, activating a RAN function may comprise executing one or more software programs for the RAN function. Deactivating a RAN function may comprise halting or stopping the execution of one or more software programs for the RAN function.

Embodiments of the disclosure thus provide a method for efficiently configuring a RAN node to use one or more RAN functions based on its configuration and performance. As the one or more RAN functions are selected based on a constraint on one or more resources of the RAN node, the performance of the RAN mode can be optimised despite any resource limitations.

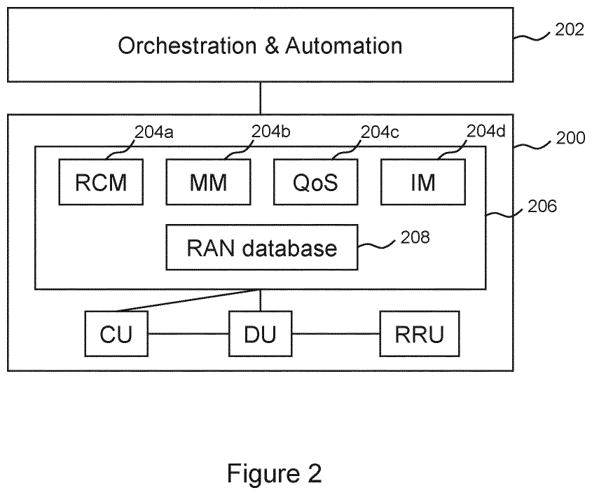

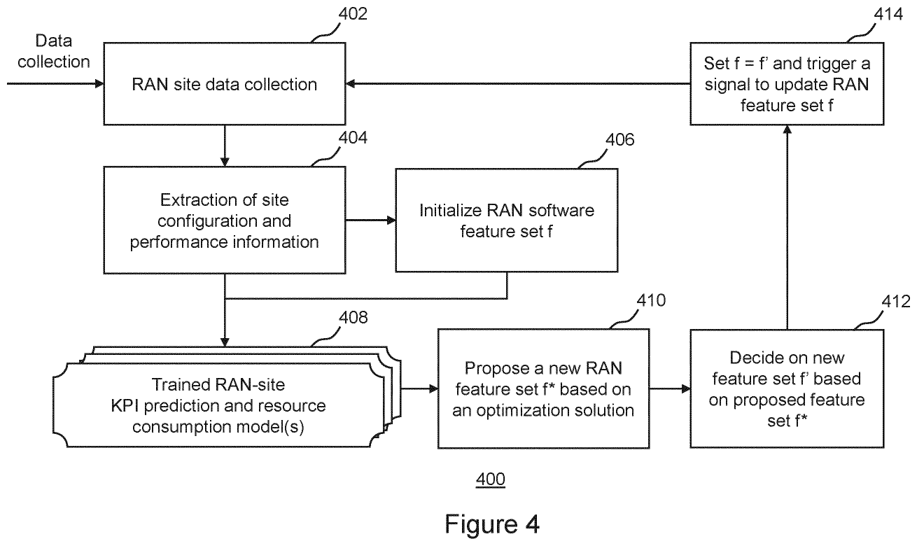

FIG. 4 shows a method 400 of configuring a RAN node to use one or more RAN functions according to embodiments of the disclosure. The RAN node may be the first RAN node 302a discussed above in respect of FIG. 3 or the O-RAN base station 200 described above in respect of FIG. 2, for example.

The method 400 begins in step 402, in which site-specific information for the RAN node is collected. In step 404, configuration and performance information is extracted from the site-specific information.

The site-specific information comprises raw data which is parsed in step 404 to obtain the configuration and performance information. The site-specific information may comprise, for example, one or more binary files and/or Extensible Markup Language (XML) files. This information may be collected periodically (e.g. by a data collection agent), thus providing regular updates on the operation and performance of the RAN node.

The configuration information relates to the operation of the RAN node. The configuration information may thus comprise, for example, one or more operational parameters for the RAN node. The operational parameters may comprise configurable parameters such as, for example, the frequency band(s) used by the first RAN node, the service state, the RAN functions currently active at the RAN node etc. The operational parameters may, additionally or alternative, comprise other static parameters which are not configurable or, at the very least, are not easily changed. These static parameters may include, for example, the location of the RAN node, the hardware at the RAN node (e.g. the number of transmit, Tx, and/or receive, Rx, antennas) etc.

The performance information may be indicative of the connectivity provided by the RAN node, thus indicating the network performance. The performance information may comprise one or more performance management (PM) counters such as, for example, one or more of: pmRrcConnEstab, pmRrcConnEstabSucc, pmRrcConnEstabAttReatt and RRCMMEOVL. The performance information may, additionally or alternatively, comprise performance indicators (such as key performance indicators, KPIs) which are calculated using PM counters. For example, the performance information may include an SSSR, which can be calculated using the pmRrcConnEstab, pmRrcConnEstabSucc, pmRrcConnEstabAttReatt and RRCMMEOVL PM counters.

The skilled person will appreciate that there are various ways in which the performance information and configuration information may be extracted from the site-specific information. Data extraction in this context may include, for example, one or more of: filtering the site-specific information to extract relevant information, combining (e.g. summing or averaging) values that are collected over a time period, calculating composite values based on a number of measurements or properties, categorising (e.g. classifying the RAN node based on the site-specific information) and any other suitable data processing techniques.

The performance information may be determined based on site-specific information collected over a predetermined time period (e.g. 15 minutes). The performance information may thus comprise one or more values (e.g. performance indicators) that are averaged over that time period. This can reduce the sensitivity of the performance information to noise in the site-specific information. The configuration information may, in contrast to the performance information, be based on site-specific information captured at a particular moment in time (e.g. a snapshot). As the configuration information is less sensitive to noise and is likely to vary over longer time periods than the performance information, using a snapshot for the configuration information can provide a good compromise between resource overhead and accuracy.

If the RAN node is not currently running any RAN functions, the method proceeds to step 406 in which an initial set of RAN functions (also referred to herein as RAN features or RAN software features), f is selected. This initial set of RAN functions may be selected based on the configuration and performance information obtained in step 404.

Alternatively, the initial set of RAN functions may be predetermined. For example, a template set of RAN functions may be used the first time the method is performed for the RAN node.

Otherwise, if the RAN node is currently running one or more RAN functions, the initial set of RAN functions, f, comprises the one or more RAN functions that are active at the RAN node (e.g. the RAN functions that are currently being used by the RAN node).

In step 408, the configuration information, performance information and initial set of RAN functions, f, are input to an optimisation process, together with a constraint on one or more resources for the RAN node and one or more target performance indicators.

The resource constraint may be in respect of any of the resources relating to the RAN node. Thus, for example, the resource constraint may comprise a constraint on one or more of the following: power consumption, processor usage (e.g. a number of processors or a proportion of processing power), memory (e.g. Random Access Memory), storage and one or more network resources. The one or more network resources may include, for example, one or more time and/or frequency resources for transmitting and/or receiving signals (e.g. a number of resource blocks such as physical resource blocks, PRBs) and/or one or more control channel elements (CCEs).

The target performance indicators specify one or more performance indicators that the optimisation process is to seek to optimise when selecting one or more RAN functions. As discussed above, optimisation can take different forms depending on the respective performance indicator and/or the particular RAN node. For example, it may be desirable to maximise some performance indicators (e.g. coverage), whereas it may be desirable to minimise others (e.g. latency). In addition, some performance indicators may be optimised by ensuring they satisfy a constraint (e.g. ensuring they have a value in a predetermined range). The one or more target performance indicators may comprise any combination of these performance indicators. Thus for example, the one or more target performance indicators may comprise a first performance indicator to be minimised and a second performance indicator that is to stay below a maximum threshold.

The target performance indicators may comprise an indication of how they should be optimised. For example, for a performance indicator that is subject to a constraint, the target performance indicator may comprise the constraint. In another example, the target performance indicator for a performance indicator that is to be maximised may comprise a flag indicating that the performance indicator is to be maximised.

Alternatively, the optimisation process may be configured to determine how to optimise the one or more performance indicators itself. For example, the optimisation process may be pre-configured to maximise one or more performance indicators. In another example, the optimisation process may be preconfigured with a constraint on a performance indicator.

In step 410, the optimisation process returns one or more RAN functions, f*, for activation by the RAN node.

The optimisation process selects the one or more RAN functions using one or more prediction models which predict, based on the configuration information, performance information and a selection of RAN functions, usage of the one or more resources and a value of the one or more target performance indicators. The optimisation process can use the prediction models to determine how changing the selection of RAN functions affects usage of the one or more (constrained) resources and the target performance indicators. The optimisation process may use the initial set of RAN functions, f, as a starting point to explore the parameter space defined by the configuration information, performance information and choice of RAN functions. Alternatively, the step of determining an initial set of RAN functions, f, may be omitted and the optimisation process may determine an initial starting point for exploring the parameter space itself.

By exploring this parameter space, the optimisation process can select a set of RAN functions, f*, which satisfies the resource usage constraint whilst optimising the performance of the RAN node as reflected in the one or more target performance indicators.

The skilled person will appreciate that there are various methods that are suitable for exploring the parameter space in this manner. The optimisation process may use any suitable process or algorithm to select the set of RAN functions using the prediction models and aforementioned inputs.

In particular embodiments, the optimisation process comprises a genetic process, also referred to as a genetic algorithm. The skilled person will be familiar with genetic processes and thus they will not be discussed in detail here. Briefly, genetic processes seek to determine an optimal solution by iteratively evolving a population of candidate solutions based on their fitness. Each candidate solution is characterised by a set of properties (or genes) that can be mutated or changed. The fitness of each candidate solution can be assessed by means of a fitness score determined using a fitness function.

In each iteration of the process, a subset of the candidate solutions is selected based on their respective fitness scores. The selected candidate solutions are combined and/or mutated to form a next generation of candidate solutions for the subsequent iteration.

By selecting candidate solutions with better fitness scores to generate the next generation, the population of candidates is evolved towards better fitness scores and thus towards more optimal solutions. The parameter space of possible candidates is explored through the process of combining and/or mutating the candidate solutions of one generation to form the candidates for the next generation.

Therefore, according to embodiments of the present disclosure, a genetic process can be used to select a set of one or more RAN functions, f, by initialising a plurality of candidate sets of RAN functions and iteratively changing the candidate sets of RAN functions. The starting population of candidate sets of RAN functions may be determined based on the initial selection of one or more RAN functions, f, for example. In each iteration of the process, the genetic process can choose to keep the candidate sets which fulfil the one or more resource constraints and optimise the value of the one or more target performance indicators. Thus, for example, if the resource constraints comprise an upper threshold on the memory required at the RAN node, the genetic process may keep only the candidate RAN functions which are predicted, according to the one or more prediction models, to keep the memory usage below this upper threshold.

In other embodiments, the optimisation process may comprise a contextual bandit process, which is also referred to as a contextual bandit algorithm. The skilled person will be familiar with contextual bandit processes and thus they will not be discussed in detail here. Briefly, a contextual bandit process is a reinforcement learning process in which a learning agent interacts with an environment and performs actions through a trial-and-error process in order to maximize a numerical reward. The learning agent iteratively chooses an action from a plurality of possible actions to take and determines the reward that results from that decision. When making a choice, the agent takes into account the rewards of actions taken in the past, as well as a feature or context vector associated with the current iteration. Through repeated iterations, the agent seeks to learn to predict, based on the feature vector, the reward associated with a chosen action. The agent can then choose an action to maximise the reward.

Therefore, according to embodiments of the present disclosure, a contextual bandit process can be used to select an optimal set of RAN functions, f. The contextual bandit process can search the plurality of RAN functions and learn how to select them to fulfil the one or more resource constraints and optimise the one or more target performance indicators. The contextual bandit process can do this by learning a mapping between context of the RAN node, as specified by the configuration information and performance information, and the selection of RAN functions that optimises a reward function.

The contextual bandit process can use a balance between exploration and exploitation to explore the potential RAN functions to better learn this mapping and to use the available configuration and performance information to optimise performance. In this context, exploitation refers to using (or activating) a set of RAN functions specified by a learning agent, whilst exploration means experimenting with new selections of RAN functions to further improve the mapping.

Both genetic processes and contextual bandit processes use an objective function to determine how well a proposed set of RAN functions fulfils the one or more resource usage constraints and optimises the target performance indicators. In the context of genetic processes, this objective function is referred to as a fitness function. For contextual bandit processes, this is referred to as a reward function.

The form of the objective function may depend on the target performance indicator. For embodiments in which the optimisation process seeks to maximise or minimise the at least one of the target performance indicators, an example of a suitable reward function is the following:

$${\sum }_{k ∈ OptimizedPIs ( S )} w ( S , k ) \cdot {PI}_{pred} ( S , f , k ) - {\sum }_{r ∈ LimitedResources ( S )} w ( S , r ) \cdot {D}_{pred} ( S , f , r )$$

in which S is the state of the RAN node as specified by the configuration and performance information. OptimizedPIs(S) is the set of at least one target performance indicators to be maximized or minimised. LimitedResources (S) is the set of resources constrained by the one or more constraints. D_{pred}(S, f, r) is the predicted demand of a resource r determined by the one or more prediction models if the set of RAN functions f were activated at the site S. PI_{pred}(S, f, k) is the predicted value of a target performance indicator k determined by the one or more prediction models. w(S, k) and w(S, r) are weightings which can be configured to adjust the relative importance of the values of different target performance indicators and the resources under constraint respectively. In general, w(S,k) may be positive for any target performance indicators which the optimization process seeks to maximise. Accordingly, w(S, k) may be negative for any target performance indicators which the optimization process seeks to minimize.

By using the aforementioned objective function, the optimization process can efficiently optimize (e.g. maximize or minimize as appropriate) the value of the target performance indicators whilst minimizing consumption of the constrained resources. However, the skilled person will appreciate that alternative objective functions may be used.

In order to ensure the one or more RAN functions selected by the optimization process are predicted to satisfy the constraint on the one or more resources, the optimization process may be subject to the following constraint:
D_{pred}(S, f, r)≤D_{cons}(S, r), ∇r∈ LimitedResources(S),
   in which D_{cons}(S, r) is the constraint on a resource r. Thus, the optimisation process may seek to maximize the objective function subject to this constraint.

In addition, as described above, the optimisation process may also be subject to a constraint on one or more of the target performance indicators. Thus, a further constraint may be applied to the optimisation process:
PI_{pred}(S, f, k)≤ConstrainedPI(S, k), ∇k∈ConstrainedPIs(S),
   in which ConstrainedPI(S) is the set of one or more target performance indicators which the optimisation process seeks to constrain (e.g. rather than maximise or minimise).

Although the aforementioned objective functions are described in the context of genetic processes and contextual bandit processes, the skilled person will appreciate that they may alternatively be used by other optimisation processes. In general, the optimisation process may select the one or more RAN functions using an objective function such as those described above. Thus, the objective function may seek to maximise or minimise an objective function when selecting the one or more RAN functions.

In step 412, a final set of RAN functions f′ for use by the RAN node is determined based on the one or more RAN functions proposed by the optimisation process, f*.

In some embodiments, a limit on the number of RAN functions that can be active at the RAN node at once may be applied in step 412. Thus a limit on the number of RAN functions that can run concurrently at the RAN node may be applied. Suppliers of RAN functions can charge a licensing fee which increases depending on the number of RAN functions which are active at a RAN node. Therefore, to reduce implementation costs, it may be determined in step 412 not to implement all of the suggested RAN functions, f*. Thus, the final set of RAN functions, f, may comprise a subset of the RAN functions, f*, suggested by the RAN node. The determination may be made by comparing the number of RAN functions proposed by the optimisation process to a maximum threshold number of RAN functions (e.g. provided by the network).

The final set of RAN functions f for the RAN node may, additionally or alternatively, be determined based on a limit on the number of changes that can be made to which RAN functions are running at the RAN node. A decision may be made to limit the number of RAN functions to be updated, even if the optimisation process generates a large set of changes. In embodiments in which the optimisation process is developed using a machine-learning process, this can mitigate risks associated with learning processes early in their training stage. Such processes can suffer from overconfidence, meaning that the optimisation process may think it performs better than it does and can therefore propose suboptimal changes. By limiting how many changes can be made (e.g. the number of RAN functions which are activated or deactivated) at once, the speed at which the optimisation process can change the active functions at the RAN node is limited, thereby providing stability.

Step 412 may, additionally or alternatively, comprise comparing the predicted values of the one or more target performance indicators for the set of RAN functions proposed by the optimisation process, f*, with the predicted values of the target performance indicators for a set of RAN functions manually selected for the RAN node by an operator (e.g. a radio engineer). If the set of RAN functions proposed by the optimisation process is predicted to perform less well than the manually selected set of RAN functions, one or more (e.g. all of) the set of RAN functions proposed by the optimisation process may be discarded. This additional check can be used to ensure that the optimisation process is performing at least as well as a manual operator. The predicted target performance indicators for both sets of RAN functions may be determined using the one or more models mentioned above. In embodiments in which the optimisation process is developed using a machine-learning process, this comparison may be particularly useful during the early stages of the learning process.

Thus, in step 412, a final set of RAN functions f for the RAN node is determined based on the set of one or more RAN functions proposed by the optimisation process, f*. The method then proceeds to step 414.

Alternatively, step 412 may be omitted, and the method may proceed directly from step 410 to step 414, such that the final set of RAN functions f′ for the RAN node corresponds to the set of RAN functions provided by the optimisation process.

In step 414, the RAN node is configured to use (e.g. run) the final set of RAN functions. Step 414 may comprise comparing the RAN functions that are currently active at the RAN node with the final set of RAN functions proposed by the optimisation process. For example, the set of RAN functions proposed by the optimisation process may include one or more RAN functions that are already running at the RAN node. Thus, in step 412, it may be determined to activate only a subset of the set of RAN functions proposed by the optimisation process, since some of the RAN functions are already active. In another example, the set of RAN functions may not include one or more RAN functions currently active at the RAN node. Thus, in step 412, it may be determined to deactivate the one or more RAN functions that are currently running but are not comprised in the set of RAN functions. In another example, the set of RAN functions proposed by the optimisation process may be identical to the RAN functions currently active at the RAN node. It may thus be determined that no RAN functions should be activated or deactivated at the RAN node.

Thus, for example, if the method 400 is performed by the RAN node itself, then the RAN node may activate (e.g. execute) one or more first RAN functions and/or deactivate (e.g. stop execution of) one or more second RAN functions based on a comparison of the final set of RAN functions with the RAN functions it is currently running.

In alternative embodiments, the method 400 may be performed by another node, such as, for example, a node in a core network which is connected to the RAN node. This other node is referred to as the optimisation node. In these embodiments, the determination as to which RAN functions to activate and/or deactivate may be made, for example, at the RAN node or the optimisation node. Thus, for example, the optimisation node may determine the one or more first RAN functions to activate and/or the one or more second RAN functions to deactivate and send an indication to the RAN node to activate the one or more first RAN functions and/or deactivate the one or more second RAN functions accordingly. Alternatively, the optimisation node may simply send an indication of the final set of RAN functions to the RAN node and the RAN node may determine which RAN functions to activate and/or deactivate based on this indication.

In some embodiments, some or all of the RAN functions in the final set of RAN functions may not be available at the RAN node. Thus, for example, the RAN node may need to obtain some or all of the RAN functions (e.g. one or more executable files) before activating them. In these examples, the RAN node may receive one or more of the final set of RAN functions from another node, referred to as a repository node, which stores one or more RAN functions. The repository node may be another RAN node or a core network node, for example. The RAN node may request, from the repository node, the RAN functions that it is missing. The RAN node may send the request of its own accord (e.g. in response to determining one or more first RAN functions to activate). Alternatively, the RAN node may be instructed to send the request by the optimisation node.

The method 400 may end in step 400 with configuring the RAN node to use the plurality of RAN functions. Alternatively, the method 400 may return to step 402, in which further site-specific information for the RAN node is collected. The method 400 may thus be repeated one or more times. In some examples, the method 400 may be performed periodically (e.g. at regular intervals) such that the RAN functions running at the RAN node are adapted according to changes in the configuration or performance of the RAN node. In other examples, the method 400 may be performed in response to a change in the configuration and/or performance information for the RAN node. For example, the method may be initiated in response to determining that an operational parameter or performance indicator has changed by more than a threshold value.

Thus, according to the method 400, the RAN node is configured to use one or more RAN functions that are selected using an optimisation process. As described above, the optimisation process uses one or more models (referred to equivalently as prediction models) to predict, based on the configuration information, performance information and a selection of RAN functions, usage of the one or more resources and a value of the one or more target performance indicators. The skilled person will appreciate that various models may be suitable for this purpose. For example, the one or more prediction models may comprise one or more theoretical models developed based on a theoretical understanding of the effects of the plurality of RAN functions on the performance and operation of the RAN node.

Additionally or alternatively, the one or more prediction models may comprise one or more models developed using training data for a plurality of RAN nodes. In this context, the plurality of RAN nodes may or may not include the RAN node for which the optimisation process is ultimately used. The training data comprises configuration information, performance information and RAN function activation information for the plurality of RAN nodes. The RAN function activation information indicates which (if any) RAN functions were active at a particular RAN node for the corresponding performance information and configuration information. The training data may thus be used to determine how different RAN functions affect the performance and/or resource usage of RAN nodes.

FIG. 5 shows an exemplary method of generating training data for training one or more prediction models. The method may be performed by a node in a core network, such as the core network 304, for example. The method may be used to generate training data for the one or more models described above in respect of FIG. 4, for example.

In step 502, site-specific information is collected for a plurality of RAN nodes 500. In FIG. 5, these RAN nodes 500 are labelled as eNBs. However, the skilled person will appreciate that the RAN nodes may comprise any combination of RAN nodes such as base stations, eNBs, gNBs etc.

The site-specific information comprises raw data from which configuration information, performance information and RAN function activation information for each of the plurality of RAN nodes can be extracted. The site-specific information may thus comprise one or more CM counters, PM counter and/or performance indicators (e.g. KPIs) for the plurality of RAN nodes, for example.

The site-specific information may be received directly from the plurality of RAN nodes 500. In one example, a data collection agent is deployed in each of the plurality of RAN nodes to collate the site-specific information for each respective RAN node. The data collection agents may send the collated information to a management node. The management node may thus receive the site-specific information for all of the plurality of RAN nodes. The management node may be any node connected to the RAN nodes which is suitable for collating the site-specific information. The management node may be an Ericsson Network Manager (ENM), for example.

In step 504, the site-specific information is processed (e.g. parsed) to obtain the configuration information, performance information and RAN function activation information. The configuration information and performance for each of the RAN nodes may be as described above in respect of FIG. 4. Thus, for example, the configuration information for a RAN node may comprise one or operational parameters, such as frequency band, number of cells, number of RX/TX antennas etc. The performance information may comprise one or more measurements indicative of network performance, such as a number of RRC connected users, PRB utilization, and/or average path loss, for example. The configuration information and performance information may differ from one RAN node to another. For example, the performance information for one RAN node may include a parameter or indicator that is not present in the performance information for another RAN node.

The RAN function activation information indicates, for each RAN node, which RAN functions were active (e.g. running) during the time period to which the performance information and configuration information relates. There are various ways in which this information may be provided. In one example, the RAN function activation information comprises a binary array, in which each of the array entries can take a value of 1 or 0. Each array entry corresponds to a RAN function and a value of 1 indicates that the associated RAN function is active, whereas a value of 0 indicates that the associated RAN function is inactive.

In step 508, the configuration information and performance information for the plurality of RAN nodes 500 is stored. This information may be stored at a centralised location 508 (e.g. a central sever) so that it is easily accessible. In particular examples, this information may be stored at a node in a core network connected to the RAN nodes, for example. The information may be stored at the management node (e.g. where the site-specific information is collated).

The data collection 502, extraction 504 and storage 506 steps may be repeated one or more times. Each iteration of the method may be triggered by, for example, a predetermined time period passing (e.g. if the method is performed periodically) or a change in the configuration or performance of at least one of the plurality of RAN nodes. When new information is extracted and stored, it may be added to any existing information stored (e.g. at a centralised location). By iteratively adding new configuration, performance and RAN function activation information over time, a robust data set for developing prediction models can be generated. Forming a larger and more comprehensive data set can improve the accuracy of any models developed using this data set.

The present disclosure thus provides a method of generating training data for developing one or more models for predicting, for a RAN node, usage of the one or more resources and a value of the one or more target performance indicators. However, the skilled person will appreciate that there are other ways of generating the training data, and thus the present disclosure is not limited as such.

FIG. 6 shows two exemplary methods for developing models using training data for a plurality of RAN nodes. The training data may comprise training data generated in accordance with the method described above in respect of FIG. 5, for example. The plurality of RAN nodes may comprise any suitable RAN nodes. The plurality of RAN nodes may thus comprise, for example, the O-RAN base station 200 described above in respect of FIG. 2 and/or the RAN nodes 302 described above in respect of FIG. 3.

FIG. 6 shows two methods: a first method 600a is for developing a model for predicting the value of one or more performance indicators (e.g. key performance indicators, KPIs) for a RAN node and a second method 600b is for developing a model for predicting a usage of one or more resources for a RAN node.

In the first method 600a, training data comprising configuration information 602a, performance information 604a and RAN function activation information 606a is used to develop a model 608a for predicting a value 610a of a target performance indicator (such as a KPI). In this example, one model 608a is developed for predicting one target performance indicator. Thus, for example, one model 608a may be developed per target performance indicator. This approach provides more accurate models since any model parameters or coefficients only need to be tuned to predict a single target performance indicator. Alternatively, one model 608a may be used to predict a plurality of target performance indicators. This approach can provide a model which less resource-intensive to run (e.g. uses less memory and/or processing power) than running multiple separate models.

According to the method 600a, the model 608a is developed by inputting the training data into a machine-learning process. The machine-learning process may comprise, for example, a regression process. Thus, the machine-learning process may comprise one or more of the following: a random forest process, a regression tree, support vector regression, a neural network, or a k-nearest-neighbours (KNN) process.

In one example, a random forest process is used to develop a model for predicting one or more target performance indicators. The hyperparameters of the random forest process comprise a number of trees=100 and unlimited tree depth. Table 1 shows the accuracy of models for predicting SSSR, Session Abnormal Release Rate (SARR), Minutes Per Abnormal Release rate including Mobility Management Entity drops (MPAR_in), Minutes Per Abnormal Release rate excluding Mobility Management Entity drops (MPAR_ex), carrier aggregation (CA, which may indicate cell availability), Handover Success rate for intra frequency handovers (HOSR_intra) and Handover Success Rate for interfrequency handovers (HOSR_inter) developed according to this example. The training accuracy column indicates the accuracy of the of the respective models when they are applied to the training data (e.g. the same data with which they were trained). The test accuracy column indicates the accuracy of the respective models when applied to unseen data (e.g. that does not overlap with the training data). The variation captures the difference between the training accuracy and the test accuracy columns.

TABLE 1

| KPIs | Training acc. (%) | Test acc. (%) | Variation |
|---|---|---|---|
| SSSR | 99.98 | 99.96 | 0.02 |
| SARR | 97.15 | 78.23 | 19.48 |
| MPAR_in | 97.35 | 77.83 | 20.05 |
| MPAR_ex | 97.41 | 81.67 | 16.15 |
| CA | 100.00 | 100.00 | 0.00 |
| HOSR_intra | 99.95 | 99.55 | 0.40 |
| HOSR_inter | 99.80 | 98.58 | 1.23 |

Table 1 shows that the method 600a can result in models for predicting target performance indicators that have accuracies between 75-100%, depending on the performance indicator.

In order to further improve the accuracy of models developed using the method 600a, domain knowledge can be used. The skilled person will be familiar with the concept of domain knowledge, but briefly domain knowledge comprises information which is specific to the domain or environment in which the model operates. Thus, the domain knowledge may relate to expertise or know-how in a particular field. Domain knowledge is typically produced using input from (human) experts in that field. Therefore, using domain knowledge in the development of a model can effectively combine the benefits of empirical models (from the site-specific information) and theoretical approaches (from the domain knowledge). In one example, the machine-learning process comprises a Bayesian learning process which uses one or more priors. The one or more priors may be based on domain knowledge. Domain knowledge may thus be used to constrain or specify one or more prior probability distributions used in the machine-learning process. For example, domain knowledge may indicate a maximum achievable value for the target parameter indication and a prior relating to the target parameter indication may be truncated to indicate that the probability of a value exceeding this maximum achievable value is zero.

In a particular example, a probabilistic Bayesian neural network may be used to predict a target performance indicator such as SSSR or MPAR. Further detail on Bayesian neural networks may be found in “Building probabilistic Bayesian neural network models with TensorFlow Probability”, Khalid Salama, 2021/01/15, https://keras.io/examples/keras recipes/bayesian neural networks/. In this approach, one or more target performance indicators may be modelled as a normal distribution. This approach requires a prior estimate of the mean and variance parameters for the one or more target performance indicators. To obtain these values, domain knowledge relating to the one or more target performance indicators may be used. For example, it is known that the typical average SSSR for real-life deployments is around 99, whereas the typical average MPAR is around 55. For the variance, it may be assumed that the variance is around 5-10% of the mean. This illustrates one example of how domain knowledge can be used to further improve the development of the one or more models for predicting a value of one or more target performance indicators.

The method 600b for developing a model to predict usage of one or more resources may be substantially the same as method 600a, but for resource usage rather than target parameter indicators. Thus, the method 600b is not described in detail here. Briefly, the method 600b comprises using training data comprising configuration information 602b, performance information 604b and RAN function activation information 606b to develop a model 608b for predicting a consumption or usage 610b of a particular resource of a RAN node. The model 608b shown in FIG. 6 is for predicting the consumption of one resource, but the skilled person will appreciate that the method 600b may in general be used to develop a model for predicting the consumption of one or more resources.

Although FIG. 6 show two separate models for predicting the value of one or more performance indicators and usage of one or more resources for a RAN node, the present disclosure is not limited as such. The methods 600a, 600b may be adapted to develop a single model for predicting both the value of one or more performance indicators and usage of one or more resources. Thus, in general, the present disclosure provides a method for developing one or more models for making these predictions.

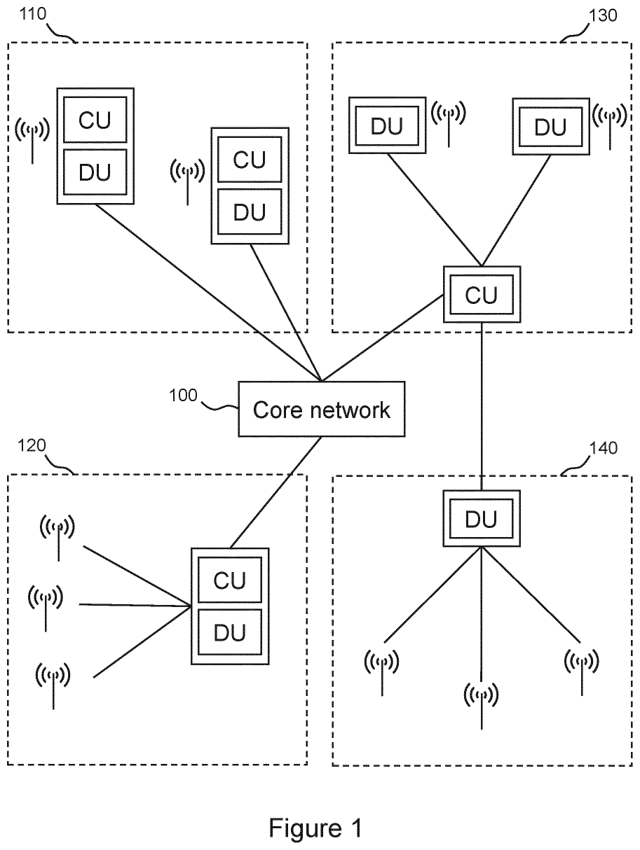

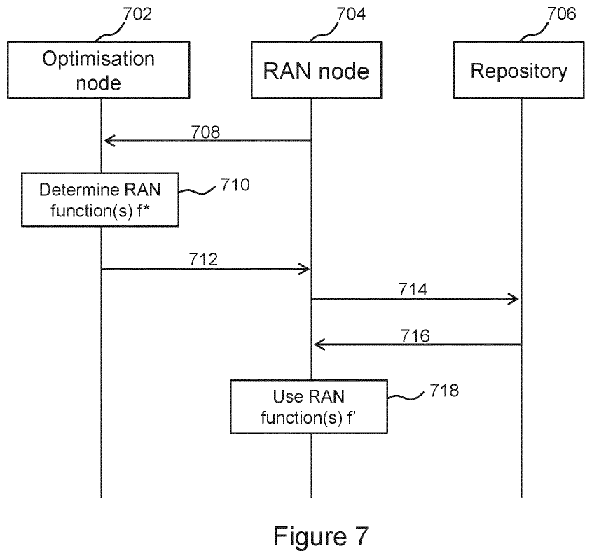

FIG. 7 shows a diagram of a signalling flow according to embodiments of the disclosure. The signalling is for configuring a RAN node 704 to use one or more RAN functions. The signalling is between an optimisation node 702, the RAN node 704 and repository 706. The optimisation node 702 may be the optimisation node described above in respect of FIG. 4, for example. The RAN node 704 may be any of the RAN nodes described herein, including, for example, the first RAN node 302a described above in respect of FIG. 1.

In step 708, the RAN node 704 sends, to the optimisation node 702, configuration information and performance information for the RAN node 704. The configuration information and performance information may be as described above in respect of any of FIGS. 3-5. Thus the RAN node 704 may have extracted the configuration information and performance information from its own site-specific information as described in respect of steps 402-404 above.

Alternatively, the RAN node 704 may send, in step 708, site-specific information for the RAN node 704. The site-specific information may be as described above in respect of FIG. 4, for example. Thus, the site-specific information may comprise data from which configuration information and performance information for the RAN node 704 can be extracted.

The RAN node 704 may send this information (e.g. either the site-specific information or the configuration and performance information) to the optimisation node 702 on request (e.g. in response to a request from the optimisation node 702) or of its own initiative. For example, the RAN node 704 may send this information at predetermined intervals.

The RAN node 704 may also send, in step 710, RAN feature activation information for the RAN node 704, indicating which RAN features are running (e.g. are active) at the RAN node 704.

In step 710, the optimisation node 702 selects one or more RAN functions from a plurality of RAN functions for the RAN node 704 based on the configuration information, performance information, one or more target performance indicators and a constraint on one or more resources for the RAN node 704.

In embodiments in which the optimisation node 702 receives site-specific information from the RAN node 704, the optimisation node 702 extracts the configuration information and performance information from the site-specific information before selecting the one or more RAN functions. The optimisation node 702 may extract this information in accordance with step 404 described above in respect of FIG. 4.

The optimisation node 702 may receive the one or more target performance indicators and the constraint from the RAN node 704 (e.g. in the message containing the configuration information and/or performance information). Alternatively, the optimisation node 702 may be preconfigured with some or all of this information. For example, the optimisation node 702 may be preconfigured with a maximum power consumption for the RAN node 704. In yet a further alternative, the optimisation node 702 may receive at least one of the target performance indicators and the constraint on one or more resources for the RAN node from another node.

The optimisation node 702 uses an optimisation process to select the one or more RAN functions using one or more models for predicting, based on the input data and a selection of RAN functions, usage of the one or more resources and a value of the one or more target performance indicators. The optimisation process may be as described in FIG. 4, such that step 710 corresponds to steps 408-412 in FIG. 4, for example. Thus, the optimisation node 702 may, in step 710, select one or more RAN functions, f* for activation by the RAN node 704 using the optimisation process.

In step 716, the optimisation node 702 configures the RNA node 704 to use the final set of one or more RAN functions by sending an indication of a final set of one or more RAN functions to the RAN node 704.

The final set of RAN functions may correspond to the one or more RAN functions f* selected in step 710. Alternatively, the final set of RAN functions may comprise a subset of the one or more RAN functions f* selected in step 710. In these examples, prior to sending the indication to the RAN node 704, the optimisation node 702 may further select a subset of the one or more RAN functions, f*, to implement. The optimisation node 702 may use any of the methods described above in step 410 of FIG. 4, for example. In these examples, the optimisation node 702 sends, in step 712, an indication of this subset of the selected RAN functions to the RAN node 704.

The optimisation node 702 may indicate the final set of RAN functions to the RAN node 704 using an array. Thus, for example, the optimisation node 702 may send the RAN node 704 an array in which each array entry corresponds to the plurality of RAN functions. Each array entry may comprise a flag indicating if the corresponding RAN function should be active (e.g. TRUE or 1) or inactive (e.g. FALSE or 0) at the RAN node 704. Alternatively, the optimisation node 702 may send the RAN node 704 a list corresponding to the final set of RAN functions.

In step 714, the RAN node 704 determines one or more first RAN functions to activate and/or one or more second RAN functions to deactivate based on the indication received from the optimisation node 702. The RAN node 704 may thus compare which RAN functions are currently running with the indication from the optimisation node 702 to determine which functions are to be activated or deactivated. For example, the RAN node 704 may determine to activate a Multi-Target RRC Connection Re-establishment function in response to determining that it was indicated by the optimisation node 702 in step 714 but is not currently running at the RAN node 704.

The RAN node 704 compares the one or more first RAN functions to activate with the RAN functions that are available (e.g. stored) at the RAN node 704. In response to determining that one or more of the functions to be activated are not stored at the RAN node 704, the RAN node 704 sends a request, 714, to the repository 706 for these functions. The repository 706 responds with the requested functions (e.g. with one or more executable files).

In step 718, the RAN node 704 activates the one or more first RAN functions (e.g. the RAN functions indicated in the message 712 that are not already running). Thus, the RAN node 704 activates any RAN functions received from the repository in step 716, along with any RAN functions stored locally that were indicated in the message 712 and are not already running. In step 718, the RAN node 704 can also deactivate any RAN functions which are currently running which are not comprised in the one or more final RAN functions. In this manner, the RAN node 704 updates its active RAN functions to correspond to those indicated by the optimisation node 702 in step 712.

In the signalling flow described in respect of FIG. 7, the RAN node 704 decides which RAN functions to activate or deactivate based on the indication of one or more final RAN functions from the optimisation node 702. Alternatively, the optimisation node 702 may, prior to sending the indication to the RAN node 704, compare RAN feature activation information for the RAN node 704 (which may be received in step 710) with the set of final RAN functions to determine one or more first RAN functions to be activated by the RAN node 704 and/or one or more second RAN functions to be deactivated by the RAN node 704. The optimisation node 704 may then send an indication of the one or more first RAN functions and/or the one or more second RAN functions to the RAN node 704 in step 712 to configure the RAN node 704 to use the one or more final RAN functions.

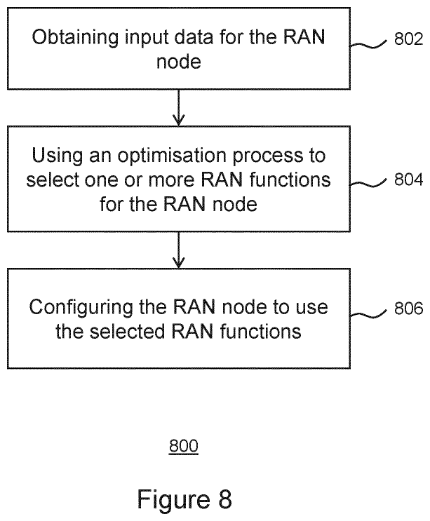

FIG. 8 shows a flowchart of a method 800 of configuring a RAN node to use one or more RAN functions according to embodiments of the disclosure. The one or more RAN functions may comprise one or more software functions or features that can be run (e.g. executed by the RAN node). The RAN node may comprise the base station 200 described above in respect of FIG. 2, for example. Alternatively, the RAN node may comprise either of the RAN nodes 302a or 704 described above in respect of FIGS. 3 and 7, for example. In particular examples, the RAN node may be a RAN node for a D-RAN, such as the D-RAN 110 described above in respect of FIG. 1.

The method may be performed by the RAN node itself. Alternatively, the method may be performed by another node connected to the RAN node, such as a node in a core network. In particular examples, the method may be implemented as a plurality of microservices (e.g. in a cloud architecture). Thus, one or more steps of the following method may be performed by a respective function. In these examples, the functions are configured to transmit any information that is necessary for the method 800 to be performed between them. The communication between the functions can use a higher-level cloud infrastructure. For example, communication between the functions can use one or more of: Kubernetes, docker or any similar service. Additionally or alternatively, the functions could use cloud storage to save data between the steps of the method 800. In a further alternative, a message bus (e.g. Kafka) could be used facilitate communications between the functions.

The method begins in step 802, in which input data for the RAN node is obtained. The input data comprises configuration information and performance information for the RAN node. Step 802 may thus correspond to steps 402-404 of FIG. 4 or step 708 of FIG. 7, for example.

In step 804, an optimisation process is used to select one or more RAN functions from a plurality of RAN functions for activation by the RAN node. The selection is made based on the input data, one or more target performance indicators and a constraint on one or more resources for the RAN node. The optimisation process is configured to select the one or more RAN functions using one or more models for predicting, based on the input data and a selection of RAN functions, usage of the one or more resources and a value of the one or more target performance indicators. Step 804 may thus correspond to steps 410-412 of FIG. 4 or step 710 of FIG. 7, for example.

The one or more models may be developed using training data for a plurality of RAN nodes, in which the training data comprises configuration information, performance information and RAN function activation information for the plurality of RAN nodes. An exemplary method for generating the training data is described above in respect of FIG. 5. Exemplary methods for developing the one or more models are described above in respect of FIG. 6.

In step 806, the RAN node is configured to use the selected RAN functions. Step 806 may correspond to step 414 of FIG. 4 or Step 712 of FIG. 7, for example. In examples in which the method 800 is performed by the RAN node, step 806 may comprise activating and/or deactivating one or more RAN functions based on the selected RAN functions. In alternative examples in which the method 800 is performed elsewhere, step 806 may comprise sending an indication to the RAN node to instruct the RAN node to use the selected RAN functions.

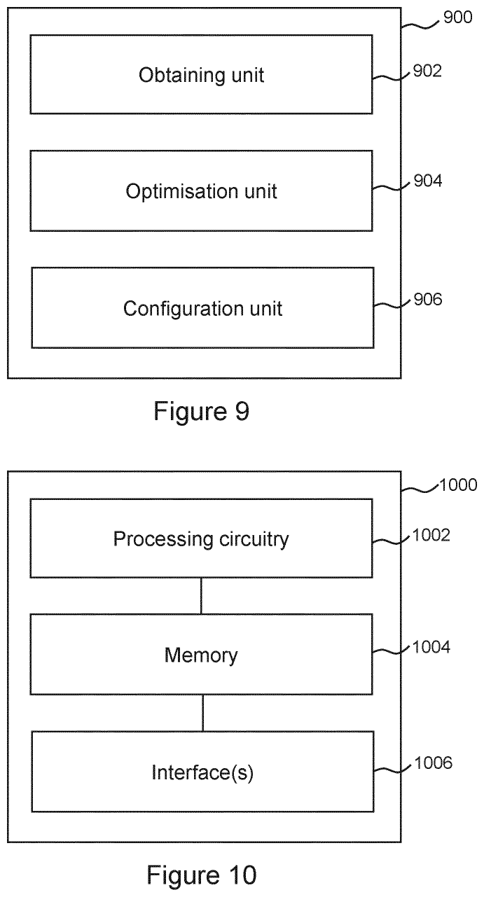

FIG. 9 is a schematic diagram of an apparatus 900 for configuring a RAN node to use one or more RAN functions according to embodiments of the disclosure. The RAN node may comprise the base station 200 described above in respect of FIG. 2, for example. Alternatively, the RAN node may comprise either of the RAN nodes 302a or 704 described above in respect of FIGS. 3 and 7, for example. In particular examples, the RAN node may be for a D-RAN.

The apparatus 1000 may be the RAN node itself. Alternatively, the apparatus 1000 may be, for example, node in a core network such as the core network 304 described above in respect of FIG. 3. The apparatus 1000 may be the orchestration and automation function 202 described above in respect of FIG. 2, for example.

The apparatus 900 may be operable to carry out the example method 800 described with reference to FIG. 8 and possibly any other processes or methods disclosed herein. It is also to be understood that the method 800 of FIG. 8 may not necessarily be carried out solely by the apparatus 900. At least some operations of the method can be performed by one or more other entities.

The apparatus 900 comprises an obtaining unit 902, which is configured to obtain input data for the RAN node, in which the input data comprising configuration information and performance information for the RAN node. The apparatus 900 further comprises an optimisation unit 904, which is configured to use an optimisation process to select one or more RAN functions from a plurality of RAN functions for the RAN node based on the input data, one or more target performance indicators and a constraint on one or more resources for the RAN node. The optimisation process is configured to select the one or more RAN functions using one or more models for predicting, based on the input data and a selection of RAN functions, usage of the one or more resources and a value of the one or more target performance indicators. The apparatus 900 further comprises a configuration unit 906, which is configured to configure the RAN node to use the one or more selected RAN functions. Thus, for example, the obtaining unit 902, the optimization unit 904 and the configuration unit 906 may be configured to perform steps 802, 804 and 806 (described above in respect of FIG. 8) respectively.

The apparatus 900 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause the obtaining unit 902, the optimization unit 904 and the initiation unit 906, and any other suitable units of apparatus 900 to perform corresponding functions according one or more embodiments of the present disclosure.

The apparatus 900 may additionally comprise power-supply circuitry (not illustrated) configured to supply the apparatus 900 with power.

FIG. 10 shows a schematic diagram of an apparatus 1000 for configuring a RAN node to use one or more RAN functions according to embodiments of the disclosure. The RAN node may comprise the base station 200 described above in respect of FIG. 2, for example. Alternatively, the RAN node may comprise either of the RAN nodes 302a or 704 described above in respect of FIGS. 3 and 7, for example. In particular examples, the RAN node may be for a D-RAN such as the D-RAN 110 described above in respect of FIG. 1.

The apparatus 1000 may be the RAN node itself. Alternatively, the apparatus 1000 may be, for example, node in a core network such as the core network 304 described above in respect of FIG. 3. The apparatus 1000 may be the orchestration and automation function 202 described above in respect of FIG. 2, for example.

The apparatus 1000 comprises processing circuitry (or logic) 1002. The processing circuitry 1002 controls the operation of the apparatus 1000 and can implement the method 800 described above with respect to FIG. 8, for example, and possibly any other processes or methods disclosed herein. The processing circuitry 1002 can comprise one or more processors, processing units, multi-core processors or modules that are configured or programmed to control the apparatus in the manner described herein. In particular implementations, the processing circuitry 1002 can comprise a plurality of software and/or hardware modules that are each configured to perform, or are for performing, individual or multiple steps of the method described herein in relation to the apparatus 1000.

Briefly, the processing circuitry 1002 of the apparatus 1000 is operable to obtain input data for the RAN node, in which the input data comprises configuration information and performance information for the RAN node. The apparatus 1000 is further operable to, based on the input data, one or more target performance indicators and a constraint on one or more resources for the RAN node, use an optimisation process to select one or more RAN functions from a plurality of RAN functions for activation by the RAN node.

The optimisation process is configured to select the one or more RAN functions using one or more models for predicting, based on the input data and a selection of RAN functions, usage of the one or more resources and a value of the one or more target performance indicators. The apparatus 1000 is further operable to configure the RAN node to use the one or more selected RAN functions.

Optionally, the apparatus 1000 may comprise a machine-readable storage medium (e.g. a memory) 1004. In some examples, the machine-readable storage medium 1004 of the apparatus 1000 can be configured to store instructions (e.g. program code) that can be executed by the processing circuitry 1002 of the apparatus 1000 to perform the method described herein in relation to the apparatus 1000. Alternatively or in addition, the machine-readable storage medium 1004 of the apparatus 1000, can be configured to store any requests, resources, information, data, signals, or similar that are described herein. The processing circuitry 1002 of the apparatus 1000 may be configured to control the machine-readable storage medium 1004 of the apparatus 1000 to store any requests, resources, information, data, signals, or similar that are described herein.

In some examples, the apparatus 1000 may optionally comprise a communications interface 1006. The communications interface 1006 of the apparatus 1000 can be for use in communicating with other nodes, such as other virtual nodes. For example, the communications interface 1006 of the apparatus 1000 can be configured to transmit to and/or receive from other nodes requests, resources, information, data, signals, or similar. The processing circuitry 1002 of the apparatus 1000 may be configured to control the communications interface 1006 of the apparatus 1000 to transmit to and/or receive from other nodes requests, resources, information, data, signals, or similar.

In the illustrated embodiment, the processing circuitry 1002, the machine-readable medium 1004 and the interfaces 1006 are operatively coupled to each other in series. In other embodiments, these components may be coupled to each other in a different fashion, either directly or indirectly. For example, the components may be coupled to each other via a system bus or other communication line.

In embodiments in which the apparatus 1000 comprises the RAN node itself, the apparatus 1000 may comprise a plurality of separate units over which the functionality of the apparatus 1000 (e.g. the functionality of the RAN node) is distributed. The apparatus 1000 may thus be a distributed (e.g. modular) RAN node such as, for example, an Open Radio Access Network (O-RAN) node.

In these embodiments, the apparatus 1000 may comprise a radio equipment controller (e.g. a baseband processing unit) and one or more remote radio equipment nodes (e.g. radio frequency transceivers). The radio equipment nodes are not co-located with the radio equipment controller and, in particular, the radio equipment nodes may be positioned at a significant distance from the radio equipment controller such that the radio equipment controller can centrally serve a large number of remote radio equipment nodes.

The radio equipment controller may be directly or indirectly connected to the remote radio equipment nodes. The radio equipment nodes may be connected to the radio equipment controller via one or more fibre links (e.g. lossless fibre links). The interface between the units in a distributed RAN node be defined by the Common Public Radio Interface (CPRI), which standardizes the protocol interface between a radio equipment controller and radio equipment nodes in wireless distributed RAN nodes to enable interoperability of equipment from different vendors. In order to reduce the number of connections (e.g. fibre links) needed, the radio equipment nodes may be connected to a common CPRI concentrator, for example.

Thus, in embodiments in which the apparatus 1000 comprises a distributed RAN node, the processing circuitry 1002 and the machine-readable medium 1004 may be comprised in, for example, a radio equipment controller which is configured to control one or more radio equipment nodes forming part of the apparatus 1000. Thus, the methods described herein (e.g. the method 400) may be performed by a radio equipment controller in the apparatus 1000. Alternatively, the processing circuitry 1002 and the machine-readable medium 1004 may be comprised in one of the radio equipment nodes (e.g. at a transceiver).

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e. the first or second of such features to occur in time or space) unless explicitly stated otherwise. Steps in the methods disclosed herein may be carried out in any order unless expressly otherwise stated. Any reference signs in the statements shall not be construed so as to limit their scope.

### Appendix A

| RAN function | Description |
|---|---|
| Downlink | Scheduling is a main function in the management |
| Frequency-Selective | of radio resources. This enables the allocation of |
| Scheduling | parts of a spectrum to a user, which can result in |
| | improved cell capacity and coverage. |
| 256-QAM | 256-QAM (Quadrature Amplitude Modulation) |
| Downlink | downlink is a 3GPP-compliant modulation that |
| | increases downlink throughput by up to 30% |
| | compared to 64-QAM modulation. This enables |
| | more efficient use of the spectrum allocated to the |
| | cell. |
| Ericsson | Reference signals are normally transmitted across |
| Lean Carrier | the entire bandwidth, even if there is no traffic in the |
| | system. Reference signals can generate |
| | interference towards neighboring cells operating |
| | on the same frequency. Reference signal induced |
| | interference is often the dominating factor limiting |
| | downlink throughput performance, particularly for |
| | higher order modulation. |
| | Ericsson Lean Carrier addresses this problem by |
| | only sending reference signals where and when |
| | they are needed to support the traffic in the system, |
| | thus minimizing harmful interference. Reference |
| | signals in the configured measurement bandwidth |
| | (e.g., central 6 Physical Resource Blocks, PRBs) |
| | are always transmitted, which means that intra- |
| | and inter-frequency reference signal received |
| | power (RSRP) measurement stability is |
| | maintained. In addition, reference signals are sent |
| | across the full bandwidth at instances when the |
| | receiving device (e.g., a wireless device) needs to |
| | read the full carrier. The Ericsson Lean Carrier |
| | function can flexibly tune the number of subframes |
| | with full reference signal bandwidth to cater for |
| | different legacy behavior for different receiving |
| | devices. It can also be used to send reference |
| | signals to only specific bands (e.g., narrowbands) |
| | for Cat-M1 receiving devices. |
| Inter-Frequency | Inter-frequency load balancing cam manage |
| Load Balancing | uneven distribution of traffic load between different |
| | carrier frequencies. It enables efficient use of |
| | network resources on multiple carrier frequencies |
| | and achieves similar user experience independent |
| | of the carrier in use. Load balancing relocating |
| | wireless devices that are in connected mode to |
| | carriers that are underused in comparison with the |
| | carrier in use. |
| Multi-Target | This function supports radio resource control |
| RRC Connection | (RRC) connection re-establishment for an Evolved |
| Re-establishment | Universal Terrestrial Radio Access (E-UTRAN) |
| | New Radio - Dual Connectivity (EN-DC) capable |
| | wireless device, with context established in both |
| | LTE RAN and NR RAN, used in a (NSA) |
| | deployment. The function initiates the secondary |
| | node release procedure during RRC connection re- |
| | establishment. |
| | The Multi-Target RRC Connection Re- |
| | establishment feature supports the re- |
| | establishment procedure in cells different than the |
| | serving cell. These include cells that belong to |
| | another RAN Node (e.g., another eNodeB) that are |
| | connected with an X2 interface. |
| | The RRC Connection Re-establishment feature |
| | (3GPP TS 36.331) makes it possible to reinstate a |
| | wireless device context with a wireless device that |
| | lost connection to the serving cell. |
| Uplink Coordinated | The Uplink Coordinated Multi-Point Reception |
| Multi-Point | function combines antenna signals from multiple |
| Reception | sector carriers in different cells to increase uplink |
| | throughput, especially for cell-border users. |
| | The uplink throughput gains of the cell-border |
| | users depend on the load and scenario. The gain |
| | is significant in a scenario where the wireless |
| | device is connected to a macro cell close to a micro |
| | cell. |
| Uplink Carrier | With this feature, a wireless device served by the |
| Aggregation | RAN node can use up to two uplink component |
| | carriers at the same time. |
| | For a wireless device is using one cell as PCell and |
| | one or more other cells as SCells, the PCell has |
| | both a downlink and an uplink component carrier. |
| | The SCells can support either downlink and uplink, |
| | or only downlink, but not only uplink. A cell can be |
| | PCell for some wireless devices and SCell for other |
| | wireless devices. |
| | The main benefits of the Uplink Carrier Aggregation |
| | feature are the following: |
| | Wireless device data transmission on more |
| | than one carrier simultaneously |
| | Up to doubled uplink wireless device |
| | throughput |
| | Increased average uplink wireless device |
| | throughput |
| | Increased application coverage for uplink |
| | demanding services |
| Interference | IRC improves the Block Error Rate (BLER) on the |
| Rejection | Physical Uplink Shared Channel (PUSCH) and |
| Combining (IRC) | Physical Uplink Control Channel (PUCCH) |
| | compared to Maximal Ratio Combining (MRC) and |
| | improves uplink throughput in uplink interference- |
| | limited systems. |
| | IRC is a method for combining antennas, which |
| | outperforms MRC when suppressing received |
| | signals. IRC uses correlations in the spatial |
| | domain (between antennas) and in the frequency |
| | domain to suppress interfering signals from other |
| | cells or in-band external interference. |
| | The use of IRC on uplink channels does not require |
| | any additional wireless device support. IRC can |
| | improve false detection and missed detection |
| | performance on the Physical Random Access |
| | Channel (PRACH) in an inter-cell interference |
| | scenario. IRC is always available on the PRACH. |
| Cell sleep | This function is operable to turn off (e.g. deactivate) |
| | one or more cells served by a RAN node when they |
| | are not needed. |
| MicroSleep TX | This function is operable to turn off a power |
| | amplifier (e.g. a major power amplifier) in a RAN |
| | node during Orthogonal Frequency Division |
| | Multiplexing (OFDM) symbols that are not used for |
| | transmitting control or data channels. |
| Multiple Input | This function is operable to dynamically change the |
| Multiple Output | radio to be configured with fewer transmission (TX) |
| (MIMO) sleep | branches when the traffic volume is detected to be |
| | low. |

1-27. (canceled)

28. A method of configuring a Radio Access Network (RAN) node to use one or more RAN functions, the method comprising:
obtaining input data for the RAN node, the input data comprising configuration information and performance information for the RAN node;
based on the input data, one or more target performance indicators and a constraint on one or more resources for the RAN node, using an optimization process to select one or more RAN functions from a plurality of RAN functions for activation by the RAN node,
the optimization process being configured to select the one or more RAN functions using one or more models for predicting, based on the input data and a selection of RAN functions, usage of the one or more resources and a value of the one or more target performance indicators; and
configuring the RAN node to use the one or more selected RAN functions.

29. The method of claim 28, wherein the one or more models are developed using training data for a plurality of RAN nodes, the training data comprising configuration information, performance information and RAN function activation information for the plurality of RAN nodes.

30. The method of claim 29, wherein the one or more models are developed by inputting the training data into a machine learning process.

31. The method of claim 30, wherein the machine-learning process comprises a Bayesian learning process and wherein one or more priors for the Bayesian learning process are based on domain knowledge.

32. The method of claim 28, wherein the one or more models comprise a first model for predicting the usage of the one or more resources and a second model for predicting a value of the one or more target performance indicators.

33. The method of claim 28, wherein the optimization process comprises a contextual bandit process or a genetic process configured to explore a parameter space defined by the plurality of RAN functions.

34. The method of claim 28, wherein the optimization process is configured to select the one or more RAN functions that are predicted to cause the constraint on the one or more resources to be satisfied when activated at the RAN node.

35. The method of claim 28, wherein the one or more target performance indicators comprise a first performance indicator and the optimization process is configured to select the one or more RAN functions that are predicted to maximise or minimize the first performance indicator when activated at the RAN node.

36. The method of claim 28, wherein the one or more target performance indicators comprise a second performance indicator and the optimization process is configured to select the one or more RAN functions that are predicted to cause the second performance indicator to satisfy a constraint on the second performance indicator when activated at the RAN node.

37. The method of claim 28, further comprising:
in response to determining that a number of selected RAN functions exceeds a threshold value, configuring the RAN node to use only a subset of the selected RAN functions.

38. The method of claim 28, wherein the optimization process is further configured to select the one or more RAN functions for activation at the RAN node based on any RAN functions currently active at the RAN node.

39. The method of claim 28, wherein the method is repeated at predetermined time intervals.

40. The method of claim 28, wherein the RAN node is in a Distributed RAN (D-RAN).

41. The method of claim 28, wherein configuring the RAN node to use the selected RAN functions comprising configuring a RAN Intelligent Controller (RIC) in the RAN node to use the selected RAN functions.

42. The method of claim 41, wherein the method is performed by a Management and Orchestration (MANO) node.

43. The method of claim 28, wherein configuring the RAN node to use the selected RAN functions comprises sending an indication of the selected RAN functions to the RAN node.

44. The method of claim 43, wherein configuring the RAN node to use the selected RAN functions further comprises instructing the RAN node to request at least one of the selected RAN functions from a RAN function repository.

45. The method of claim 28, wherein the method is performed by the RAN node and configuring the RAN node to use the selected RAN functions comprises one or more of the following:
activating one or more first RAN functions of the selected RAN functions; and
deactivating one or more second RAN functions of the plurality of RAN functions.

46. The method of claim 45, further comprising:
requesting, from a RAN function repository, at least one of the one or more first RAN functions.

47. The method of claim 45, further comprising:
determining the one or more first RAN functions and/or the one or more second RAN functions based on a comparison of the selected RAN functions with any RAN functions currently active at the RAN node.

48. The method of claim 28, wherein each of the plurality of RAN functions comprises one or more executable software programs.

49. A non-transitory computer-readable medium comprising, stored thereupon, a computer program comprising instructions configured so that, when executed on at least one processor, the instructions cause the at least one processor to carry out the method of claim 28.

50. An apparatus for configuring a Radio Access Network (RAN) node to use one or more RAN functions, the apparatus comprising processing circuitry and a machine-readable medium, the machine-readable containing instructions executable by the processing circuitry such that the apparatus is operable to:
obtain input data for the RAN node, the input data comprising configuration information and performance information for the RAN node;
based on the input data, one or more target performance indicators and a constraint on one or more resources for the RAN node, use an optimization process to select one or more RAN functions from a plurality of RAN functions for activation by the RAN node,
the optimization process being configured to select the one or more RAN functions using one or more models for predicting, based on the input data and a selection of RAN functions, usage of the one or more resources and a value of the one or more target performance indicators; and
configure the RAN node to use the one or more selected RAN functions.
